(19) United States
(12) Patent Application Publication
(10) Pub. No.: US 2004/0209124 A1
(43) Pub. Date: Oct. 21, 2004

(54) Polymer electrolyte and the use thereof in galvanic cells

(76) Inventors: Michael Schmidt, Seeheim -Jugenheim (DE); Frank Ott, Griesheim (DE); Winfried Geissler, Rossdorf (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/487,020

(22) PCT Filed: Jul. 25, 2002
(86) PCT No.: PCT/EP02/08287

(30) Foreign Application Priority Data
Aug. 17, 2001 (DE) 101 39 409.8

(51) Int. Cl. B32B 9/00

(52) U.S. Cl. 428/697

(57) ABSTRACT

The invention relates to mixtures of borate or phosphate salts, especially spiroborate or spirophosphate salts, and polymers in addition to the use thereof in electrolytes, batteries, capacitors, supercapacitors and galvanic cells.

The present invention relates to mixtures of borate or phosphate salts and polymers, and to the use thereof in electrolytes, batteries, capacitors, supercapacitors and galvanic cells.

The spread of portable electronic equipment, such as, for example, laptop and palmtop computers, mobile telephones or video cameras, and thus also the demand for lightweight and high-performance batteries has increased dramatically worldwide in recent years. In view of this suddenly increased demand for batteries and the associated ecological problems, the development of rechargeable batteries having a long service life and high performance is attracting constantly increasing importance.

In particular, the quality of the electrolytes has a major influence on the service life and performance of the batteries, and consequently there has been no lack of attempts in the past continuously to improve the electrolytes. In the known electrolyte systems, a distinction is usually made between liquid and solid electrolytes, with solid electrolytes covering both polymer electrolytes as well as gel or hybrid electrolytes.

Battery cells based on liquid electrolytes generally have relatively good ionic conductivities, but tend to leak, which then results in the release of liquids which are potentially hazardous to humans and to the environment. In addition, the production of battery cells of this type is restricted with respect to the possible sizes and shapes of these cells.

Polymer electrolytes are usually based on an optionally crosslinked polymer and a conductive salt. However, conventional polymer electrolytes frequently only exhibit low ionic conductivities, which do not meet the high demands made of modern batteries.

The term gel or hybrid electrolytes is taken to mean electrolyte systems which contain a solvent in addition to an optionally crosslinked polymer and a conductive salt. The crosslinking of these polymers is frequently carried out at relatively high temperatures in the presence of the conductive salts. The corresponding conductive salts therefore have to have relatively high thermal stability in solution, since otherwise there is a risk of their decomposition and thus also a reduction in the ionic conductivity of the resultant gel electrolyte.

Owing to its low thermal stability, LiPF₆, which is the most widespread commercial salt in liquid electrolytes, is not suitable for use in polymer or gel electrolytes. In addition, LiPF₆ is extremely sensitive to hydrolysis. In contact with moist air or with residual water from the solvents, hydrofluoric acid HF can rapidly form. In addition to its toxic properties, HF has a very adverse effect on the cycle behaviour and thus on the service life and performance of the electrochemical cells.

In order to avoid these disadvantages, alternative lithium salts have been proposed. For example, imides, in particular bis(trifluoromethylsulfonyl)imide, are proposed in U.S. Pat. No. 4,505,997, and methanides, in particular tris(trifluoromethylsulfonyl)methanide, are proposed in U.S. Pat. No. 5,273,840. These salts have high thermal stability and are able to form solutions of high conductivity with organic aprotic solvents. In accordance with the prior art, they are therefore frequently employed in polymeric and gel-type electrolytes.

However, the aluminium usually employed as cathodic collector is not adequately passivated by imides (L. A. Dominey, Current State of Art on Lithium Battery Electrolyte in G. Pistoia (Ed.) Lithium Batteries; New Materials, Development and Perspectives, Amsterdam, Elsevier, 1994 and the literature cited therein). By contrast, methanides can only be prepared and purified with very great effort. In addition, the electrochemical properties, such as oxidation stability and passivation of aluminium, are very highly dependent on the purity of the methanide.

EP 698 301 and WO 98/07729 disclose lithium spiroborates containing aromatic ligands and the use thereof as conductive salts in galvanic cells. Use of these salts as conductive salts in polymer electrolytes is not described. DE 198 29 030 and DE 199 33 898 describe two salts, lithium bis(oxalato)borate and lithium tris(oxalato)phosphate, and the use thereof as conductive salts. Polymer electrolytes based on these salts are likewise not disclosed here.

The invention had the object of providing electrolytes which do not have the disadvantages of the prior art. The object was therefore to provide electrolytes which have high thermal stability in addition to good ionic conductivity. A further object of the present invention was to extend or improve the service life and performance of batteries, capacitors, supercapacitors and galvanic cells.

Surprisingly, this object is achieved by the provision of mixtures according to claim 1.

The invention is distinguished by the fact that the mixture comprises

a) at least one borate salt of the general formula (I)

M^{x+}[B(OR¹)ₙ(OR²)ₘ(OR³)ₒ(OR⁴)ₚ]ₓ⁻ (I)

or at least one phosphate salt of the general formula (II)

M^{x+}[P(OR¹)ₙ(OR²)ₘ(OR³)ₒ(OR⁴)ₚ(OR⁵)_{q}(OR⁶)ᵣ]ₓ⁻ (II)

and b) at least one polymer.

In the salts of the general formulae (I) and (II):

1≦x≦3

M^{x+} is a monovalent, divalent or trivalent cation, preferably Li⁺, Na⁺, Mg²⁺, Ca²⁺, Al³⁺, NH₄⁺ or NR₄⁺, where R are identical or different alkyl or aryl groups having from 1 to 8 carbon atoms, which may be substituted by further alkyl and/or aryl groups and in which one CH₂ group may be replaced by an O atom,

0≦n, m, o, p≦4, where n+m+o+p=4 in (I)

or 0≦n, m, o, p, q, r≦6, where n+m+o+p+q+r=6 in (II), and R¹, R², R³,

R⁴, R⁵ and R⁶ are identical, different or different in pairs, are optionally bonded directly to one another via a single or double bond, and each have, individually or together, the meaning

of an aromatic or heteroaromatic ring, preferably phenyl, naphthyl, anthracenyl, phenanthrenyl, pyridyl, pyrazyl or pyrimidyl,

of an alkyl group having from 1 to 8 carbon atoms,

of an aromatic or aliphatic carbonyl, carbonylcarboxyl, sulfonyl or carboxyl group having from 1 to 12 carbon atoms,

where some or all of the R¹, R², R³, R⁴, R⁵ and R⁶ defined above may be substituted by further groups, preferably by F, Cl, Br, N(CₙF₍₂ₙ₊₁₋ₓ)Hₓ)₂, O(CₙF₍₂ₙ₊₁₋ₓ)Hₓ), SO₂(CₙF₍₂ₙ₊₁₋ₓ)Hₓ) or CₙF₍₂ₙ₊₁₋ₓ)Hₓ, where 1≦n≦6 and 1≦x≦2n+1.

For the purposes of the present invention, the term mixture covers pure mixtures of components a) and b), mixtures in which the salt of component a) is included in the polymer of component b), and mixtures in which chemical and/or physical bonds exist between the salt of component a) and the polymer of component b).

In a preferred embodiment, the mixture according to the invention can comprise component a) in an amount of from 3 to 99% by weight and component b) in an amount of from 97 to 1% by weight. The mixture can particularly preferably comprise component a) in an amount of from 10 to 99% by weight and component b) in an amount of from 90 to 1% by weight. The weight ratios indicated above are in each case based on the sum of components a) and b).

The mixtures according to the invention preferably each comprise one salt of the general formula (I) or (II) as component a) and one polymer of component b). In this way, particularly good reproducibility of the electrochemical properties can be achieved. However, the mixtures according to the invention may also each comprise two or more salts of the general formulae (I) and (II) as component a) and/or two or more polymers of component b).

It is also possible to employ the salts of the general formula (I) or (II) in the form of a mixture with further lithium salts known to the person skilled in the art in the mixtures according to the invention.

They can be used in proportions of between 1 and 99% in combination with other conductive salts which are used in electrochemical cells. Suitable are, for example, conductive salts selected from the group consisting of LiPF₆, LiBF₄, LiClO₄, LiAsF₆, LiSO₃, CF₃, LiN(SO₂ CF₃)₂, LiC(SO₂ CF₃)₃, LiN(SO₂ C₂F₅)₂, LiB(O₄C₂)₂ and Li[FₓP(CₙF₂ₙ₊₁)₆₋ₓ] where 1≦x≦5 and 1≦n≦8, and mixtures thereof.

In a preferred embodiment, the salts of the general formula (I) or (II) in the mixtures according to the invention are spiroborate or spirophosphate salts.

The mixtures particularly preferably comprise salts of the general formula (I) or (II), whose anions are selected from the following group:

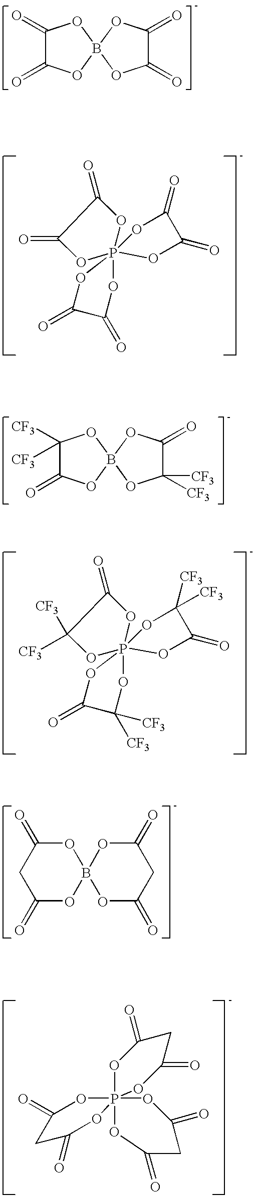

Without restricting generality, further examples of suitable anions of the formulae (I) and (II) for the mixtures according to the invention are the following:

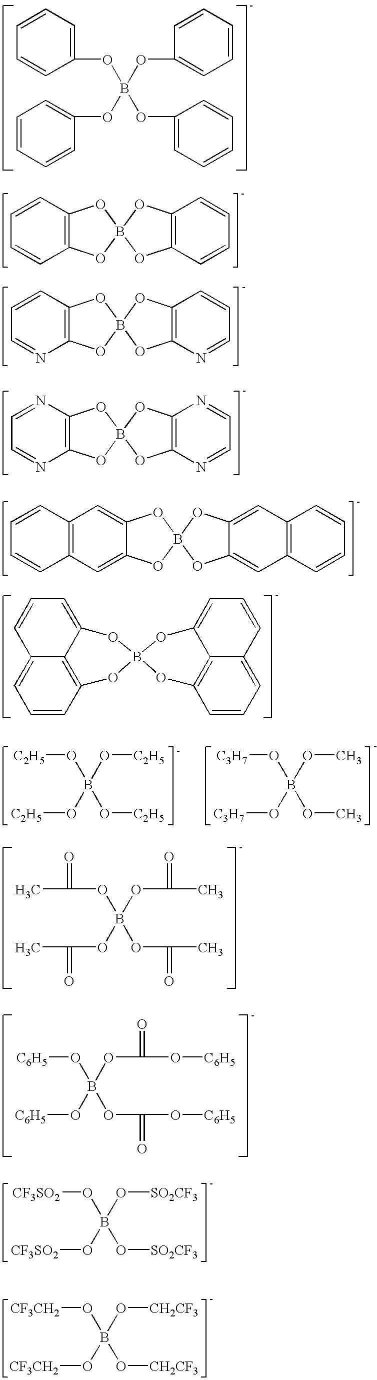

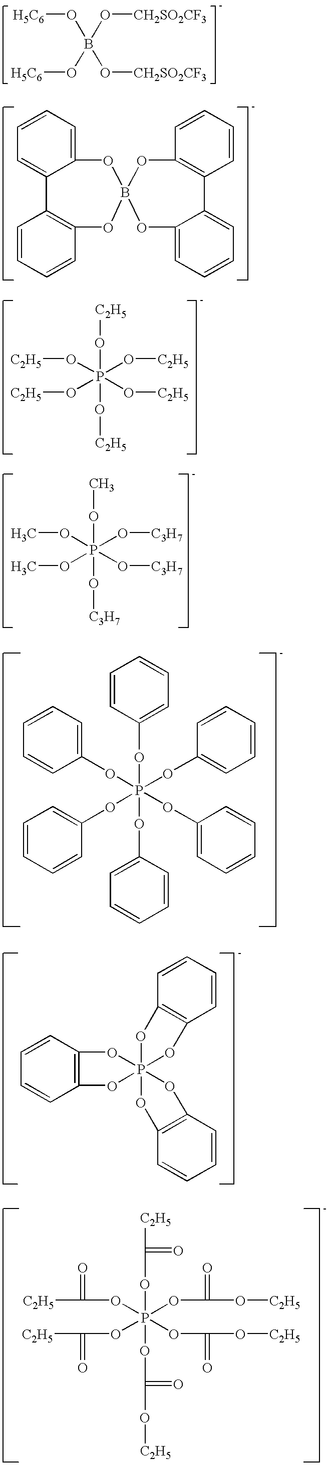

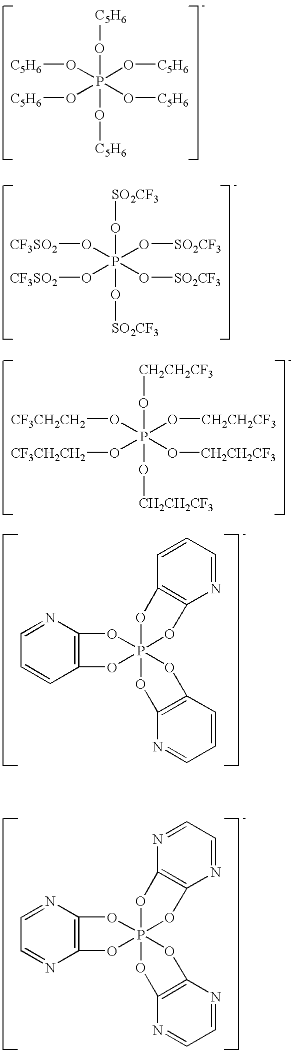

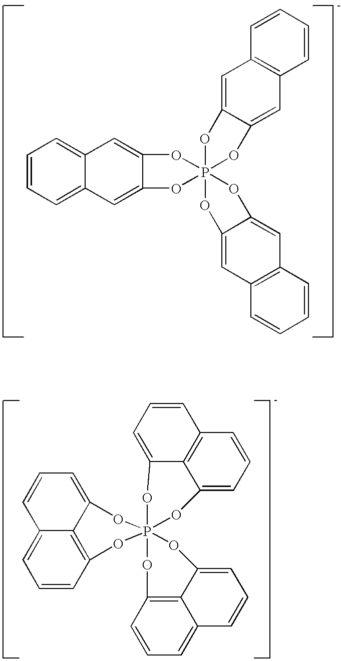

As component b), the mixture according to the invention preferably comprises a homopolymer or copolymer of unsaturated nitriles, preferably acrylonitrile, vinylidenes, preferably vinylidene difluoride, methacrylates, preferably methyl methacrylate, cyclic ethers, preferably tetrahydrofuran, alkylene oxides, preferably ethylene oxide, siloxane, phosphazene, alkoxysilanes or organically modified ceramics, marketed, for example, under the trade name ORMOCERE®, or a mixture of at least two of the above-mentioned homopolymers and/or copolymers.

Component b) is particularly preferably a homopolymer or copolymer of vinylidene difluoride, acrylonitrile, methyl (meth)acrylate or tetrahydrofuran, very particularly preferably a homopolymer or copolymer of vinylidene difluoride. These homopolymers and copolymers of vinylidene difluoride are marketed, for example, by Atofina Chemicals, Inc., under the name Kynar® and Kynarflex® and by Solvay under the name Solef®.

Furthermore, the polymers employed in accordance with the invention may be at least partially crosslinked. The crosslinking can be carried out with known crosslinking agents by conventional methods known to the person skilled in the art.

In addition to the salts of the general formulae (I) and (II) and the polymers, the mixture according to the invention may additionally comprise a solvent or a mixture of two or more solvents.

Preferred solvents are organic carbonates, organic esters, organic ethers, organic amides, sulfur-containing solvents, aprotic solvents or at least partially fluorinated derivatives of the above-mentioned solvents, or mixtures of at least two of these solvents, and/or fluorinated derivatives of these solvents.

The organic carbonates used are preferably ethylene carbonate, propylene carbonate, butylene carbonate, dimethyl carbonate, diethyl carbonate, ethyl methyl carbonate, vinylene carbonate or methyl propyl carbonate, the organic esters used are preferably methyl formate, ethyl formate, methyl acetate, ethyl acetate, methyl propionate, ethyl propionate, methyl butyrate, ethyl butyrate or γ-butyrolactone, the organic ethers used are preferably diethyl ether, dimethoxyethane or diethoxyethane, the organic amides used are preferably dimethylformamide or dimethylacetamide, the sulfur-containing solvents used are preferably dimethyl sulfoxide, dimethyl sulfite, diethyl sulfite or propane sultone, and the aprotic solvents used are preferably acetonitrile, acrylonitrile or acetone.

The invention furthermore relates to a process for the preparation of lithium salts of the general formula (I) in electrochemically pure quality (>99%), in which lithium hydroxide or lithium carbonate is reacted with boric acid or boron trioxide and the corresponding ligand of the salt of the general formula (I) by a process known to the person skilled in the art, where, in accordance with the invention, use is exclusively made of solvents which have a high electrochemical voltage window, such as, for example, organic carbonates. For the purposes of the present invention, a high electrochemical voltage window is E_{red}<1.5 V against Li/Li⁺ and Eₒₓ≧4.5 V against Li/Li⁺. The solvents used are preferably exclusively open-chain carbonates, in particular dimethyl carbonate, diethyl carbonate and/or ethyl methyl carbonate.

The invention furthermore relates to lithium salts of the general formula (I) in electrochemically pure quality (>99%). These can be obtained by reaction of lithium hydroxide or lithium carbonate with boric acid or boron trioxide and the corresponding ligand of the salt of the general formula (I) by using exclusively solvents which have a high electrochemical voltage window.

Only the exclusive use of these solvents in accordance with the invention gives rise to extremely pure lithium salts of the general formula (I), as was hitherto impossible in the processes of the prior art. (Trace) contamination by interfering solvents, such as, for example, acetonitrile or ethers, is advantageously prevented in this way since the solvents used in accordance with the invention can be used as standard in electrochemical cells. This prevents impairment of the performance of the electrochemical cells (for example cycle stability, drop in capacity, storage stability). This applies particularly to high-energy lithium batteries.

The invention also relates to the lithium salts defined in claims 17 and 18.

The invention furthermore relates to the use of at least one mixture according to the invention in electrolytes, primary and secondary batteries, capacitors, supercapacitors and galvanic cells.

The invention furthermore relates to electrolytes, primary batteries, secondary batteries, capacitors, supercapacitors and galvanic cells which contain at least one mixture according to the invention and optionally further lithium salts and/or additives. These further lithium salts and additives are known to the person skilled in the art from, for example, Doron Aurbach, Nonaqueous Electrochemistry, Marc Dekker Inc., New York 1999; D. Linden, Handbook of Batteries, Second Edition, McGraw-Hill Inc., New York 1995 and G. Mamantov and A. I. Popov, Chemistry of Nonaqueous Solutions, Current Progress, VCH Verlagsgemeinschaft, Weinheim 1994. They are hereby incorporated by way of reference and are thus regarded as part of the disclosure.

Organic isocyanates (DE 199 44 603) may be present in order to reduce the water content.

Compounds of the general formula (DE 9941566)

[([R¹(CR²R³)ₖ]ₗAₓ)_{y}Kt]⁺ ⁻N(CF₃)₂

where

Kt is N, P, As, Sb, S or Se

A is N, P, P(O), O, S, S(O), SO₂, As, As(O), Sb or Sb(O)

R¹, R² and R³ are identical or different and are H, halogen, substituted and/or unsubstituted alkyl CₙH₂ₙ₊₁, substituted and/or unsubstituted alkenyl having 1-18 carbon atoms and one or more double bonds, substituted and/or unsubstituted alkynyl having 1-18 carbon atoms and one or more triple bonds, substituted and/or unsubstituted cycloalkyl CₘH₂₋ₘ, mono- or polysubstituted and/or unsubstituted phenyl, or substituted and/or unsubstituted heteroaryl,

where

n=1-18

m=3-7

k=0 or 1-6

1=1 or 2 in the case where x=1 and 1 in the case where x=

x=0 or 1

y=14,

A may be included in R¹, R² and/or R³ in various positions,

Kt may be included in a cyclic or heterocyclic ring, and

the groups bonded to Kt may be identical or different,

may also be present.

The mixtures according to the invention may also be present in electrolytes which comprise compounds of the formula (DE 199 466 73)

X—(CYZ)ₘ—SO₂N(CR¹R²R³)₂

where

X is H, F, Cl, CₙF₂ₙ₊₁, CₙF₂ₙ₋₁ or (SO₂)ₖN(CR¹R²R³)₂

Y is H, For Cl

Z is H, For Cl

R¹, R² and R³ are H and/or alkyl, fluoroalkyl or cycloalkyl

m is 0-9 and, if X═H, m ≠0

n is 1-9

k is 0 if m=O and k=1 if m=1-9.

The electrolyte may also comprise lithium complex salts of the formula (DE 199 32 317)

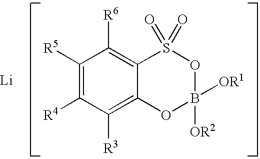

where

R¹ and R² are identical or different, are optionally bonded directly to one another via a single or double bond, and are each, individually or together, an aromatic ring from the group consisting of phenyl, naphthyl, anthracenyl and phenanthrenyl, which may be unsubstituted or mono- to hexa-substituted by alkyl (C₁ to C₆), alkoxy groups (C₁ to C₆) or halogen (F, Cl or Br),

or are each, individually or together, an aromatic heterocyclic ring from the group consisting of pyridyl, pyrazyl and pyrimidyl, which may be unsubstituted or mono- to tetrasubstituted by alkyl (C₁ to C₆), alkoxy groups (C₁ to C₆) or halogen (F, Cl or Br), or are each, individually or together, an aromatic ring from the group consisting of hydroxybenzocarboxyl, hydroxynaphthalenecarboxyl, hydroxybenzosulfonyl and hydroxynaphthalenesulfonyl, which may be unsubstituted or mono- to tetrasubstituted by alkyl (C₁ to C₆), alkoxy groups (C₁ to C₆) or halogen (F, Cl or Br),

R³ to R⁶ may each, individually or in pairs and optionally bonded directly to one another via a single or double bond, have the following meanings:

1. alkyl (C₁ to C₆), alkoxy (C₁ to C₆) or halogen (F, Cl or Br)

2. an aromatic ring from the groups consisting of phenyl, naphthyl, anthracenyl and phenanthrenyl, which may be unsubstituted or mono- to hexasubstituted by alkyl (C₁ to C₆), alkoxy groups (C₁ to C₆) or halogen (F, Cl or Br), pyridyl, pyrazyl and pyrimidyl, which may be unsubstituted or mono- to tetrasubstituted by alkyl (C₁ to C₆), alkoxy groups (C₁ to C₆) or halogen (F, Cl or Br).

It is also possible to use electrolytes comprising complex salts of the general formula (DE 199 51 804)

M^{x+}[EZ]_{x/y}^{y-}

in which

x and y are 1, 2, 3, 4, 5 or 6

M^{x+} is a metal ion

E is a Lewis acid selected from the group consisting of BR¹R²R³, AlR¹R²R³PR¹R²R³R⁴R⁵, AsR¹R²R³R⁴R⁵ and VR¹R²R³R⁴R⁵, where

R¹ to R⁵ are identical or different, are optionally bonded directly to one another via a single or double bond, and may each, individually or together, be

a halogen (F, Cl or Br),

an alkyl or alkoxy group (C₁ to C₈), which may be partially or fully substituted by F, Cl or Br,

an aromatic ring, optionally bonded via oxygen, from the group consisting of phenyl, naphthyl, anthracenyl and phenanthrenyl, which may be unsubstituted or mono- to hexasubstituted by alkyl (C, to C₈) or F, Cl or Br,

an aromatic heterocyclic ring, optionally bonded via oxygen, from the group consisting of pyridyl, pyrazyl and pyrimidyl, which may be unsubstituted or mono- to tetrasubstituted by alkyl (C₁ to C₈) or F, Cl or Br, and

Z is OR¹, NR⁶R⁷, CR⁶R⁷R⁸, OSO₂R⁶, N(SO₂R⁶)(SO₂R⁷), C(SO₂R⁶)(SO₂R⁷)(SO₂R⁸) or OCOR⁶, where

R⁶ to R⁸ are identical or different, are optionally bonded directly to one another via a single or double bond, and are each, individually or together, hydrogen or as defined for R¹ to R⁵.

Borate salts (DE 199 59 722) of the general formula

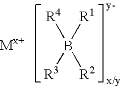

in which

M is a metal ion or tetraalkylammonium ion,

x and y are 1, 2, 3, 4, 5 or 6,

R¹ to R⁴ are identical or different and are alkoxy or carboxyl groups (C₁-C₈), which are optionally bonded directly to one another via a single or double bond, may also be present.

Additives, such as silane compounds of the general formula (DE 100 276 26)

SiR¹R²R³R⁴

where

R¹ to R⁴ are H

C_{y}F_{2y+1-z}H_{z}

OC_{y}F_{2y+1-z}H_{z}

OC(O)C_{y}F_{2y+1-z}H_{z} or

OSO₂C_{y}F_{2y+1-z}H_{z}

where 1≦x≦6

1≦y≦8 and

0≦z<2y+1

and

R¹ to R⁴ are identical or different and are an aromatic ring from the group consisting of phenyl and naphthyl, which may be unsubstituted or monosubstituted or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1-z}H_{z} or N(CₙF_{2n+1-z}H_{z})₂, or

are a heterocyclic aromatic ring from the group consisting of pyridyl, pyrazyl and pyrimidyl, each of which may be monosubstituted or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1-z}H_{z} or N(CₙF_{2n+1-z}H_{z})

may also be present.

The mixtures according to the invention may also be employed in electrolytes comprising lithium fluoroalkylphosphates of the following formula (DE 100 089 55)

Li⁺[PFₓ(C_{y}F_{2y+1-z}H_{z})₆₋ₓ]⁻

in which

1≦x≦5

3≦y≦8

0≦z≦2y+1

and the ligands (C_{y}F_{2y+1-z}H_{z}) may be identical or different, with the exception of the compounds of the general formula

Li⁺[PFₐ(CH_{b}F_{c}(CF₃)_{d})ₑ]

in which a is an integer from 2 to 5, b=0 or 1, c=0 or 1, d=2 and e is an integer from 1 to 4, with the provisos that b and c are not simultaneously each 0, and the sum a+e is equal to 6, and the ligands (CH_{b}F_{c}(CF₃)_{d}) may be identical or different.

The process for the preparation of lithium fluoroalkylphosphates is characterised in that at least one compound of the general formula

HₘP(CₙH₂ₙ₊₁)₃₋ₘ,

OP(CₙH₂ₙ₊₁)₃,

ClₘP(CₙH₂ₙ₊₁)₃₋ₘ,

FₘP(CₙH₂ₙ₊₁)₃₋ₘ,

ClₒP(CₙH₂ₙ₊₁)₅₋ₒ,

FₒP(CₙH₂ₙ₊₁)₅₋ₒ,

in each of which

0<m<2, 3<n<8 and 0<o<4,

is fluorinated by electrolysis in hydrogen fluoride, the resultant mixture of fluorination products is separated by extraction, phase separation and/or distillation, and the resultant fluorinated alkylphosphorane is reacted with lithium fluoride in an aprotic solvent or solvent mixture with exclusion of moisture, and the resultant salt is purified and isolated by conventional methods.

The mixtures according to the invention may also be employed in electrolytes which comprise salts of the formula (DE 100 16 801)

Li[P(OR¹)ₐ(OR²)_{b}(OR³)_{c}(OR⁴)_{d}Fₑ]

in which 0<a+b+c+d≦5 and a+b+c+d+e=6, and R¹ to R⁴, independently of one another, are alkyl, aryl or heteroaryl groups, where at least two of R¹ to R⁴ may be bonded directly to one another via a single or double bond.

The compounds are prepared by reaction of phosphorus(V) compounds of the general formula

P(OR¹)ₐ(OR²)_{b}(OR³)_{c}(OR⁴)_{d}Fₑ

in which 0<a+b+c+d≦5 and a+b+c+d+e=5, and R¹ to R⁴ are as defined above, with lithium fluoride in the presence of an organic solvent.

The electrolyte may also comprise ionic liquids of the general formula (DE 100 265 65)

K⁺A⁻

in which K⁺ is a cation selected from the group consisting of

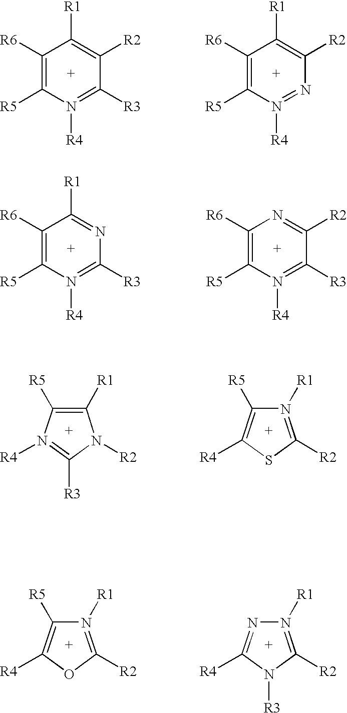

where R¹ to R⁵ are identical or different, are optionally bonded directly to one another via a single or double bond, and each, individually or together, have the following meanings:

H,

halogen,

an alkyl group (C₁ to C₈), which may be partially or fully substituted by further groups, preferably F, Cl, N(CₙF(₂ₙ₊₁₋ₓ)Hₓ)₂, O(CₙF₍₂ₙ₊₁₋ₓ)Hₓ), SO₂(CₙF₍₂ₙ₊₁₋ₓ)Hₓ) or CₙF₍₂ₙ₊₁₋ₓ)Hₓ, where 1<n<6 and 0<x≦13 and

A⁻ is an anion selected from the group consisting of [B(OR¹)ₙ(OR²)ₘ(OR³)ₒ(OR⁴)ₚ]

where 0≦n, m, o, p≦4, and m+n+o+p=4, where

R¹ to R⁴ are different or are identical in pairs, are optionally bonded directly to one another via a single or double bond, and are each, individually or together,

an aromatic ring from the group consisting of phenyl, naphthyl, anthracenyl and phenanthrenyl, which may be unsubstituted or monosubstituted or polysubstituted by CₙF₍₂ₙ₊₁₋ₓ)Hₓ, where 1<n<6 and 0<x≦13, or halogen (F, Cl or Br),

an aromatic heterocyclic ring from the group consisting of pyridyl, pyrazyl and pyrimidyl, which may be unsubstituted or monosubstituted or polysubstituted by CₙF₍₂ₙ₊₁₋ₓ)Hₓ, where 1<n<6 and 0<x≦13, or halogen (F, Cl or Br),

an alkyl group (C₁ to C₈), which may be partially or fully substituted by further groups, preferably F, Cl, N(CₙF₍₂ₙ₊₁₋ₓ)Hₓ)₂, O(CₙF₍₂ₙ₊₁₋ₓ)Hₓ), SO₂(CₙF₍₂ₙ₊₁₋ₓ)Hₓ) or CₙF₍₂ₙ₊₁₋ₓ)Hₓ, where 1<n<6 and 0<x≦13,

or OR¹ to R⁴,

individually or together, are an aromatic or aliphatic carboxyl, dicarboxyl, oxysulfonyl or oxycarboxyl group, which may be partially or fully substituted by further groups, preferably F, Cl, N(CₙF₍₂ₙ₊₁₋ₓ)Hₓ)₂, O(CₙF₍₂ₙ₊₁₋ₓ)Hₓ), SO₂(CₙF₍₂ₙ₊₁₋ₓ)Hₓ) or CₙF₍₂ₙ₊₁₋ₓ)Hₓ, where 1<n<6 and 0<x≦13.

Ionic liquids K⁺ A⁻ (DE 100 279 95), where K⁺ is as defined above and A⁻ is an anion selected from the group consisting of

[PFₓ(C_{y}F_{2y+1-z}H_{z})₆₋ₓ]⁻

where 1≦x<6

1≦y≦8 and

0≦z≦2y+1,

may also be present.

The mixtures according to the invention can be employed in electrolytes for electrochemical cells which contain anode material consisting of coated metal cores selected from the group consisting of Sb, Bi, Cd, In, Pb, Ga and tin or alloys thereof (DE 100 16 024).

The process for the production of this anode material is characterised in that

a) a suspension or sol of the metal or alloy core in urotropin is prepared,

b) the suspension is emulsified with C₅-C₁₂-hydrocarbons,

c) the emulsion is precipitated onto the metal or alloy cores, and

d) the metal hydroxides or oxyhydroxides are converted into the corresponding oxide by heat-treatment of the system.

The mixtures according to the invention can also be employed in electrolytes for electrochemical cells having cathodes made from common lithium intercalation and insertion compounds, but also with cathode materials consisting of lithium mixed oxide particles coated with one or more metal oxides (DE 199 22 522) by suspending the particles in an organic solvent, adding a solution of a hydrolysable metal compound and a hydrolysis solution to the suspension, and then filtering off, drying and optionally calcining the coated particles.

They can also consist of lithium mixed oxide particles coated with one or more polymers (DE 199 46 066), obtained by a process in which the particles are suspended in a solvent, and the coated particles are subsequently filtered off, dried and optionally calcined.

The mixtures according to the invention may likewise be employed in systems having cathodes consisting of lithium mixed oxide particles with one or more coatings of alkali metal compounds and metal oxides (DE 100 14 884). The process for the production of these materials is characterised in that the particles are suspended in an organic solvent, an alkali metal salt compound suspended in an organic solvent is added, metal oxides dissolved in an organic solvent are added, a hydrolysis solution is added to the suspension, and the coated particles are subsequently filtered off, dried and calcined.

The mixtures according to the invention can likewise be employed in systems comprising anode materials with doped tin oxide (DE 100 257 61). This anode material is prepared by

a) adding urea to a tin chloride solution,

b) adding urotropin and a suitable doping compound to the solution,

c) emulsifying the resultant sol in petroleum ether,

d) washing the resultant gel and removing the solvent by suction, and

e) drying and heating the gel.

The mixtures according to the invention can likewise be employed in systems comprising anode materials with reduced tin oxide (DE 100 25 762). This anode material is prepared by

a) adding urea to a tin chloride solution,

b) adding urotropin to the solution,

c) emulsifying the resultant sol in petroleum ether,

d) washing the resultant gel and removing the solvent by suction,

e) drying and heating the gel, and

f) exposing the resultant SnO₂ to a reducing gas stream in an aeratable oven.

The mixtures according to the invention have the advantage of exhibiting no signs whatever or virtually no signs of thermal decomposition over a very broad temperature range.

The mixtures according to the invention furthermore have high thermal, chemical and electrochemical stability. This applies in particular to mixtures which comprise salts of bisoxalatoborate, of bismalonatoborate or of bis[bis(trifluoromethyl)hydroxyacetato]borate.

These properties enable electrolytes, batteries, capacitors, supercapacitors and galvanic cells which contain these mixtures according to the invention to be employed even under extreme conditions, such as, for example, at high temperatures, without their service life and performance being impaired by these conditions.

The corresponding batteries, capacitors, supercapacitors and galvanic cells are furthermore distinguished by very good voltage constancy, and unrestricted ability to function over many charge/discharge cycles.

The use of the mixtures according to the invention in large batteries, as used, for example, in electric road vehicles or hybrid road vehicles, is likewise very advantageous since toxic and strongly etching hydrogen fluoride is not formed in the case of damage to the batteries, such as, for example, in the case of an accident, even on contact with water, for example through atmospheric moisture or extinguishing water.

Without restriction of generality, the mixtures according to the invention are explained in greater detail with reference to working examples.

### WORKING EXAMPLES

### Example 1

Synthesis of a Lithium bis(oxalato)borate Polymer Electrolyte

Step 1:

Synthesis of Lithium bis(oxalato)borate

189.0 g of oxalic acid*2H₂O (1.5 mol), 31.5 g of lithium hydroxide*H₂O (0.75 mol) and 46.4 g of boric acid (0.75 mol) and 700 ml of diethyl carbonate were initially introduced. The white, readily stirrable suspension formed was refluxed for 40 minutes under inert conditions, and the water formed was removed by azeotropic distillation. After addition of a further 300 ml of diethyl carbonate, the azeotropic distillation was continued for a further 2 hours, and the remaining diethyl carbonate was stripped off under reduced pressure. The product was then washed a number of times with diethyl carbonate and dried under reduced pressure at 140° C. to constant weight.

Yield 89.7%

Step 2:

Preparation of the Polymer/Gel Electrolyte

1 g (5% by weight) of crosslinked polyvinylidene difluoride copolymer (Kynarflex®, Atofina Chemicals, Inc.) was added to 20 g of a 1 molar solution of lithium bis(oxalato)borate in ethylene carbonate/diethyl carbonate (1:1). The suspension was subsequently heated to a temperature of from 50 to 60° C. until the copolymer had completely dissolved and was then cooled to room temperature. The consistency of the polymer electrolyte during this operation can be controlled via the proportion of copolymer. Up to a concentration of about 3% by weight of copolymer, a highly viscous liquid electrolyte is obtained. At a concentration of from about 3 to about 10% by weight of copolymer, a gelatinous electrolyte is obtained, and from a concentration of about 10% by weight, a solid polymer electrolyte is obtained.

### Example 2

Synthesis of a Lithium Tris(oxalato)phosphate Polymer Electrolyte

The synthesis of lithium tris(oxalato)phosphate is carried out in accordance with DE 199 33 898.

The preparation of the lithium tris(oxalato)phosphate polymer/gel electrolyte is carried out analogously to step 2 from Example 1.

### Example 3

Synthesis of a Lithium bis[Bis(trifluoromethyl)hydroxyacetato]Borate Polymer Electrolyte

Step 1:

Synthesis of Lithium bis[Bis(trifluoromethyl)hydroxyacetato]Borate

Water is removed from 0.31 mol of bis(trifluoromethyl)hydroxyacetic acid, 0.155 mol of boric acid and 0.155 mol of lithium hydroxide*H₂O in 600 ml of diethyl carbonate by azeotropic distillation for 70 minutes. Diethyl carbonate is then distilled off over the course of 3 hours, and diethyl carbonate is replenished in 3*200 ml portions during the 3 hours. The colourless, slightly cloudy solution is filtered and evaporated at 80° C. under reduced pressure.

Step 2:

The preparation of the lithium bis[bis(trifluoromethyl)hydroxyacetato]borate polymer/gel electrolyte is carried out analogously to step 2 from Example 1.

### Example 4

Synthesis of a Lithium tris[bis(trifluoromethyl)hydroxyacetato]Phosphate Polymer Electrolyte

Step 1:

The synthesis of lithium tris[bis(trifluoromethyl)hydroxyacetato]phosphate is carried out analogously to lithium tris(oxalato)phosphate in accordance with DE 199 33 898 with the difference that bis(trifluoromethyl)hydroxyacetic acid is employed as ligand instead of oxalic acid.

Step 2:

The preparation of the lithium tris[bis(trifluoromethyl)hydroxyacetato]phosphate polymer/gel electrolyte is carried out analogously to step 2 from Example 1.

1. Mixture comprising
a) at least one borate salt of the general formula (I)
M^{x+}[B(OR¹)ₙ(OR²)ₘ(OR³)ₒ(OR⁴)ₚ]ₓ⁻ (I)
where
1≦x≦3
M^{x+} is a monovalent, divalent or trivalent cation, preferably Li⁺, Na⁺, Mg²⁺, Ca²⁺, Al³⁺, NH₄⁺ or NR₄⁺,
where R are identical or different alkyl or aryl groups having from 1 to 8 carbon atoms, which may be substituted by further alkyl and/or aryl groups and in which one CH₂ group may be replaced by an O atom,
0≦n, m, o, p≦4, where n+m+o+p=4, and
R¹, R², R³ and R⁴ are identical, different or different in pairs, are optionally bonded directly to one another via a single or double bond, and each have, individually or together, the meaning
of an aromatic or heteroaromatic ring, preferably phenyl, naphthyl, anthracenyl, phenanthrenyl, pyridyl, pyrazyl or pyrimidyl,
of an alkyl group having from 1 to 8 carbon atoms,
of an aromatic or aliphatic carbonyl, carbonylcarboxyl, sulfonyl or carboxyl group having from 1 to 12 carbon atoms,
where some or all of the R¹, R², R³ and R⁴ defined above may be substituted by further groups, preferably by F, Cl, Br, N(CₙF₍₂ₙ₊₁₋ₓ)Hₓ)₂, O(CₙF₍₂ₙ₊₁₋ₓ)Hₓ), SO₂(CₙF₍₂ₙ₊₁₋ₓ)Hₓ) or CₙF₍₂ₙ₊₁₋ₓ)Hₓ, where 1≦n≦6 and 0≦x≦2n+1,
or at least one phosphate salt of the general formula (II)
M^{x+}[P(OR¹)ₙ(OR²)ₘ(OR³)ₒ(OR⁴)ₚ(OR⁵)_{q}(OR⁶)ᵣ]ₓ (II)
where
1≦x≦3
M^{x+} is a monovalent, divalent or trivalent cation, preferably Li⁺, Na⁺, Mg²⁺, Ca²⁺, Al³⁺, NH₄⁺ or NR₄⁺,
where R are identical or different alkyl or aryl groups having from 1 to 8 carbon atoms, which may be substituted by further alkyl and/or aryl groups and in which one CH₂ group may be replaced by an O atom,
0≦n, m, o, p, q, r≦6, where n+m+o+p+q+r=6, and
R¹, R², R³,
R⁴, R⁵ and R⁶ are identical, different or different in pairs, are optionally bonded directly to one another via a single or double bond, and each have, individually or together, the meaning
of an aromatic or heteroaromatic ring, preferably phenyl, naphthyl, anthracenyl, phenanthrenyl, pyridyl, pyrazyl or pyrimidyl,
of an alkyl group having from 1 to 8 carbon atoms,
of an aromatic or aliphatic carbonyl, carbonylcarboxyl, sulfonyl or carboxyl group having from 1 to 12 carbon atoms,
where some or all of the R¹, R², R³, R⁴, R⁵ and R⁶ defined above may be substituted by further groups, preferably by F, Cl, Br, N(CₙF₍₂ₙ₊₁₋ₓ)Hₓ)₂, O(CₙF₍₂ₙ₊₁₋ₓ)Hₓ), SO₂(CₙF₍₂ₙ₊₁₋ₓ)Hₓ) or CₙF₍₂ₙ₊₁₋ₓ)Hₓ, where 1≦n≦6 and 0≦x≦2n+1, and
b) at least one polymer.

2. Mixture according to claim 1,
characterised in that it comprises from 3 to 99% by weight of component a) and from 97 to 1% by weight of component b), preferably from 10 to 99% by weight of component a) and from 90 to 1% by weight of component b), in each case based on the sum of components a) and b).

3. Mixture according to claim 1, characterised in that component a) is at least one spiroborate or spirophosphate salt.

4. Mixture according to claim 1, characterised in that component a) is at least one salt with an anion selected from the following group:

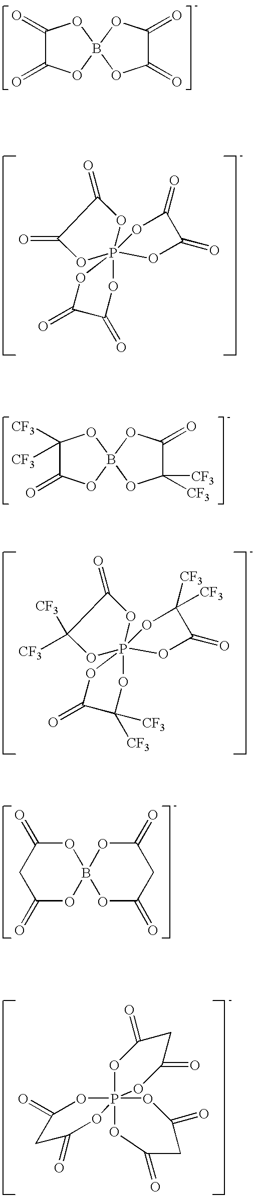

5. Mixture according to claim 1, characterised in that the polymer of component b) is a homopolymer or copolymer of unsaturated nitrile, vinylidene, methacrylate, cyclic ether, alkylene oxide, siloxane, phosphazene or a mixture of at least two of the above-mentioned homopolymers and/or copolymers.

6. Mixture according to claim 4, characterised in that the polymer of component b) is a homopolymer or copolymer of acrylonitrile, vinylidene difluoride, methyl (meth)acrylate, tetrahydrofuran, ethylene oxide, siloxane, phosphazene or a mixture of at least two of the above-mentioned homopolymers and/or copolymers.

7. Mixture according to claim 1, characterised in that component b) is a homopolymer or copolymer of acrylonitrile, vinylidene difluoride, methyl (meth)acrylate, tetrahydrofuran, preferably a homopolymer or copolymer of vinylidene difluoride.

8. Mixture according to claim 1, characterised in that the polymer is at least partially crosslinked.

9. Mixture according to claim 1, characterised in that it additionally comprises at least one solvent.

10. Mixture according to claim 1, characterised in that the solvent is an organic carbonate, preferably ethylene carbonate, propylene carbonate, butylene carbonate, dimethyl carbonate, diethyl carbonate, ethyl methyl carbonate, vinylene carbonate or methyl propyl carbonate,
an organic ester, preferably methyl formate, ethyl formate, methyl acetate, ethyl acetate, methyl propionate, ethyl propionate, methyl butyrate, ethyl butyrate or γ-butyrolactone,
an organic ether, preferably diethyl ether, dimethoxyethane or diethoxyethane,
an organic amide, preferably dimethylformamide or dimethylacetamide,
a sulfur-containing solvent, preferably dimethyl sulfoxide, dimethyl sulfite, diethyl sulfite or propane sultone,
an aprotic solvent, preferably acetonitrile, acrylonitrile or acetone,
or an at least partially fluorinated derivative of the above-mentioned solvents or a mixture of the above-mentioned solvents.

11. Process for the preparation of lithium salts of the general formula (I) in electrochemically pure quality,
in which lithium hydroxide or lithium carbonate is reacted with boric acid or boron trioxide and the corresponding ligand of the salt of the general formula (I), characterised in that use is exclusively made of solvents which have a high electrochemical voltage window.

12. Process according to claim 11, characterised in that the solvent used is one or more organic carbonates, in particular open-chain carbonates.

13. Process according to claim 12, characterised in that the solvent used is dimethyl carbonate, diethyl carbonate and/or ethyl methyl carbonate.

14. Lithium salts of the general formula (I) in electrochemically pure quality, obtainable by reaction of lithium hydroxide or lithium carbonate with boric acid or boron trioxide and the corresponding ligand of the salt of the general formula (I), characterised in that use is exclusively made of solvents which have a high electrochemical voltage window.

15. Lithium salts according to claim 14, characterised in that the solvent used is one or more organic carbonates, in particular open-chain carbonates.

16. Lithium salts according to claim 15, characterised in that the solvent used is dimethyl carbonate, diethyl carbonate and/or ethyl methyl carbonate.

17. Lithium bis[bis(trifluoromethyl)hydroxyacetato]borate,

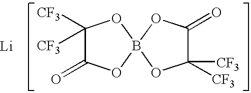

18. Lithium tris[bis(trifluoromethyl)hydroxyacetato]phosphate,

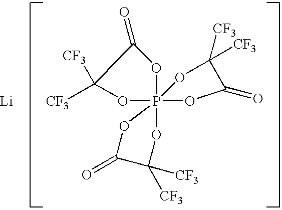

19. Use of at least one mixture according to claim 1 in electrolytes, primary batteries, secondary batteries, capacitors, supercapacitors or galvanic cells.

20. Electrolytes, primary batteries, secondary batteries, capacitors, supercapacitors or galvanic cells containing at least one mixture according to claim 1.
